(19) United States
(12) Patent Application Publication
(10) Pub. No.: US 2020/0397193 A1
(43) Pub. Date: Dec. 24, 2020

(54) COOKING ROBOT WITH FOOD INGREDIENT PROCESSING AND COOKING STRUCTURE

(71) Applicant: Kum Hee Han, Gunpo-si (KR)

(72) Inventor: Kum Hee Han, Gunpo-si (KR)

(21) Appl. No.: 16/535,032

(22) Filed: Aug. 7, 2019

(30) Foreign Application Priority Data
Jun. 18, 2019 (KR) 10-2019-0072183

(51) Int. Cl. A47J 44/00; A23L 23/00; A23L 5/10

(52) U.S. Cl. CPC A47J 44/00; A23V 2002/00; A23L 5/15; A23L 23/00

(57) ABSTRACT

A cooking robot comprises an ingredient preparing housing, the ingredient preparing housing including an ingredient entry hole through which a food ingredient is put and a cutting chamber with a cutting means and an ingredient cooking housing including a heat cooking chamber configured to receive the processed food ingredient from the ingredient preparing housing, heat, and cook the food ingredient, the heat cooking chamber including a first heating panel and a second heating panel at a lower side thereof. The cutting means includes a cutting cylinder formed at an inner upper side of the cutting chamber, a cutting panel formed at a cutting shaft of the cutting cylinder, and cutting blades formed at the cutting panel and spaced apart from each other at predetermined intervals.

### CROSS-REFERENCE TO RELATED APPLICATION(S)

This application is based on and claims priority under 35 U.S.C. 119 to Korean Patent Application No. 10-2019-0072183, filed on Jun. 18, 2019, in the Korean Intellectual Property Office, the disclosure of which is herein incorporated by reference in its entirety.

### TECHNICAL FIELD

Embodiments of the disclosure relate to a cooking device or system, and more specifically, to a cooking robot with a food ingredient processing and automatic cooking structure, which may prevent accidents, shorten cooking time, and enable cooking of various foods.

### DESCRIPTION OF RELATED ART

Typically, at home or restaurant, food ingredients are cleaned, trimmed, and chopped to prepare for cooking. The prepared food ingredients are heated by a cooking tool, thereby cooking a food.

Such cooking process is carried out over heated, thus very hot, cooking tools and, thus, puts the cook at risk, e.g., skin burns and may fail to guarantee consistent results or cooking times depending on the skill of the cook or may inhale hazardous gases produced from cooking. Thus, a need exists for a way to address such issues.

### SUMMARY

According to an embodiment, a cooking robot comprises an ingredient preparing housing, the ingredient preparing housing including an ingredient entry hole through which a food ingredient is put and a cutting chamber with a cutting means and an ingredient cooking housing including a heat cooking chamber configured to receive the processed food ingredient from the ingredient preparing housing, heat, and cook the food ingredient, the heat cooking chamber including a first (top) heating panel and a second (bottom) heating panel at a lower side thereof. The cutting means includes a cutting cylinder formed at an inner upper side of the cutting chamber, a cutting panel formed at a cutting shaft of the cutting cylinder, and cutting blades formed at the cutting panel and spaced apart from each other at predetermined intervals. The ingredient cooking housing further includes an oil feeder configured to supply oil to ingredients between the first (top) heating panel and the second (bottom) heating panel.

The ingredient preparing housing may include a crushing chamber configured to crush the food ingredient such as garlic. A crushing panel with a plurality of crushing holes may be provided at an upper side of the crushing chamber.

The ingredient preparing housing may include a mixing chamber with a mixing/kneading means. The mixing/kneading means may include a bowl casing disposed in the mixing chamber, a connecting shaft with a first end fastened to an inner side of the mixing chamber, a mixing motor fastened to a second end of the connecting shaft, and a mixing/kneading unit coupled to a mixing shaft of the mixing motor.

The ingredient cooking housing may include a soup cooking chamber configured to cook a soup. The soup cooking chamber may include a soup heating panel at a lower side thereof. A supply tube may be formed to supply water to the soup cooking chamber in the ingredient cooking housing, and a discharge tube is formed to discharge the cooked soup. The ingredient cooking housing may further include a source supplying unit configured to supply a seasoning or sauce to the soup cooking chamber.

The ingredient cooking housing may further include a pressing/heating means configured to press and heat an upper portion of the food ingredient on the first heating panel and the second heating panel. The pressing/heating means may include a first operation cylinder formed on an inner side surface of the heat cooking chamber and disposed over the first heating panel, a second operation cylinder formed on an inner side surface of the heat cooking chamber and disposed over the second heating panel, a first elevation pressing/heating panel formed at an operation shaft of the first operation cylinder to be moved up or down by operation of the first operation cylinder, and a second elevation pressing/heating panel formed at an operation shaft of the second operation cylinder to be moved up or down by operation of the second operation cylinder. The first elevation pressing/heating panel may be disposed over the first heating panel to press and heat an upper portion of the food ingredient on the first heating panel, and the second elevation pressing/heating panel may be disposed over the second heating panel to press and heat an upper portion of the food ingredient.

A conveying cylinder may be installed on the operation shaft of the second operation cylinder to prevent the incoming food ingredient from being stuck and to evenly press and heat the upper portion of the food ingredient on the second heating panel. The second elevation pressing/heating panel may be installed on a conveying shaft of the conveying cylinder to be moved up or down by the second operation cylinder and conveyed by operation of the conveying cylinder.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a perspective view illustrating a cooking robot with a food ingredient processing and automatic cooking structure according to an embodiment;

FIG. 2 is a front view illustrating a cooking robot with a food ingredient processing and automatic cooking structure according to an embodiment;

FIG. 3 is a plan view illustrating a cooking robot with a food ingredient processing and automatic cooking structure according to an embodiment;

FIG. 4 is a cross-sectional view illustrating a cooking robot with a food ingredient processing and automatic cooking structure according to an embodiment;

FIG. 5 is a view illustrating an operation state of a cooking robot with a food ingredient processing and automatic cooking structure according to an embodiment;

FIG. 6 is a view illustrating a cutting means of a cooking robot with a food ingredient processing and automatic cooking structure according to an embodiment;

FIG. 7 is a cross-sectional view illustrating a cooking robot with a food ingredient processing and automatic cooking structure according to an embodiment;

FIG. 8 is a cross-sectional view illustrating an operation state of a cooking robot with a food ingredient processing and automatic cooking structure according to an embodiment;

FIG. 9 is a cross-sectional view illustrating an operation state of a pressurizing/heating means of a cooking robot with a food ingredient processing and automatic cooking structure according to an embodiment; and

FIG. 10 is a cross-sectional view illustrating an operation state of a conveying cylinder of a cooking robot with a food ingredient processing and automatic cooking structure according to an embodiment.

### DETAILED DESCRIPTION OF EXEMPLARY EMBODIMENTS

Hereinafter, exemplary embodiments of the disclosure are described below in detail with reference to the accompanying drawings. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present. The line drawings illustrated and the size of the elements may be exaggerated for the purpose of clarity or illustration. The terms as used herein are defined considering the functions in the present invention and may be replaced with other terms according to the intention or practice of the user or operator. Therefore, the terms should be defined based on the overall disclosure.

The following embodiments should not be interpreted as limiting the scope of the disclosure and, without limited thereto, there may be other various embodiments of the disclosure.

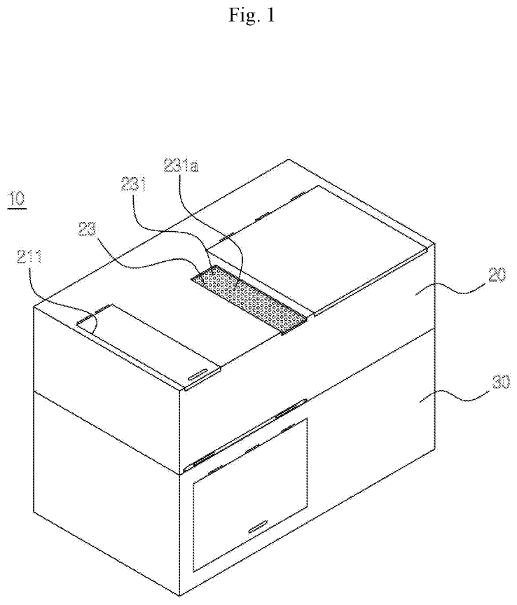

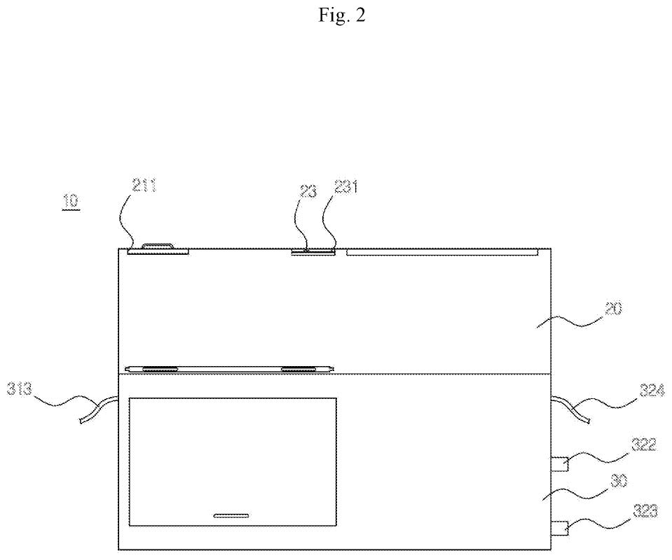

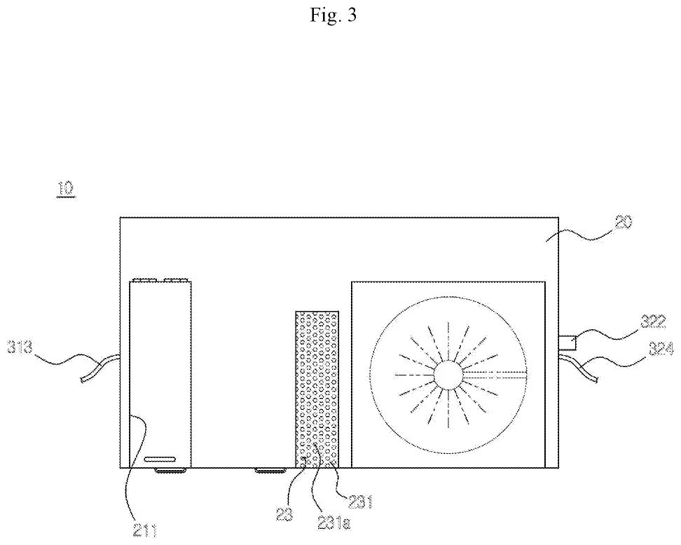

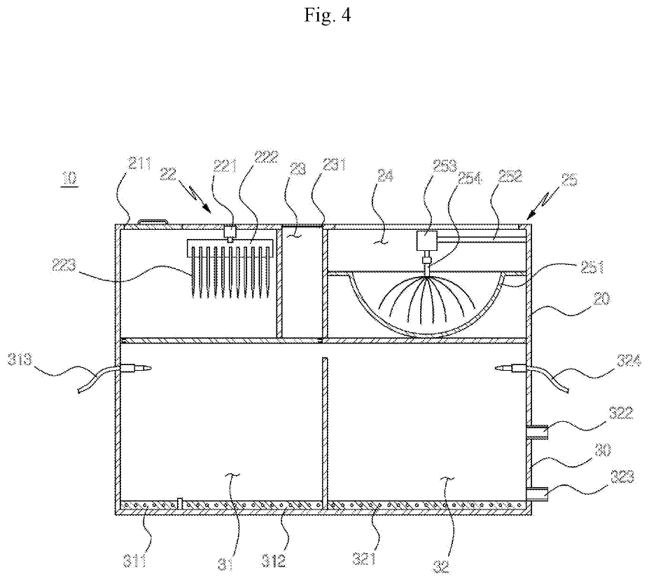

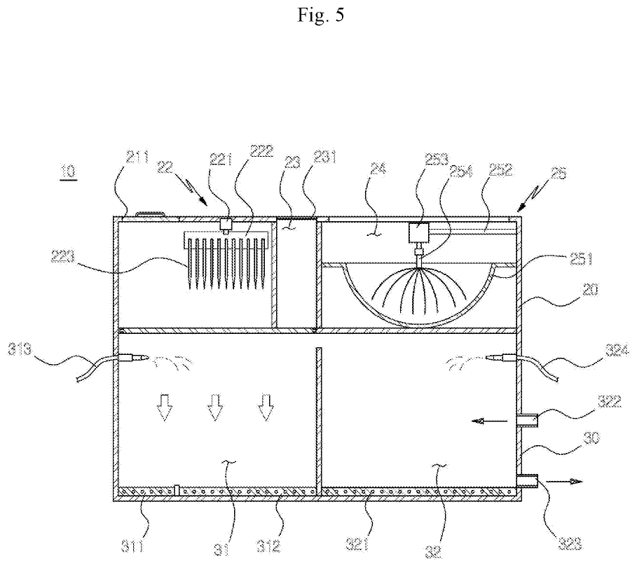

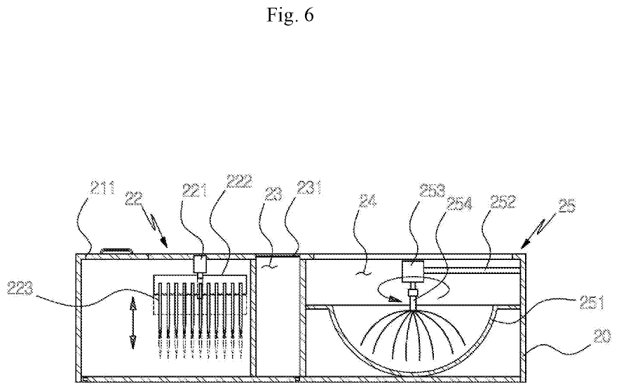

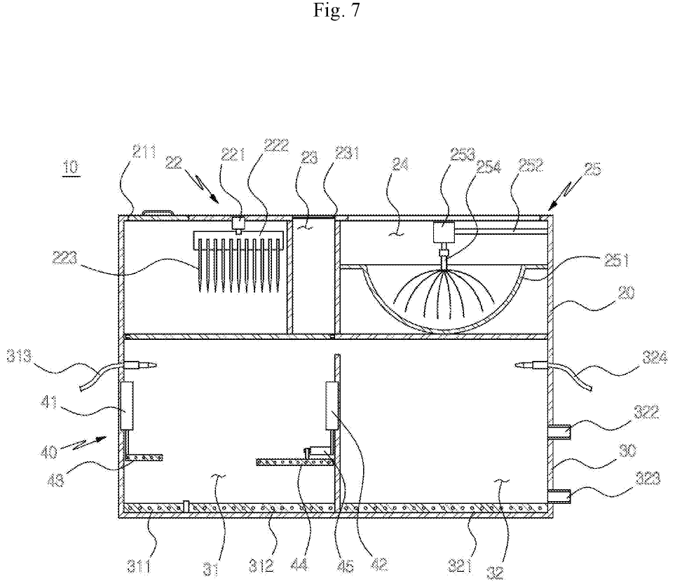

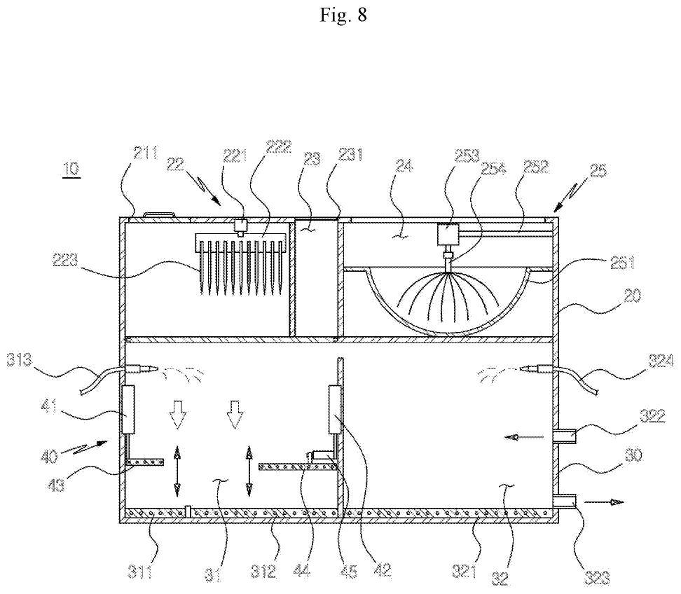

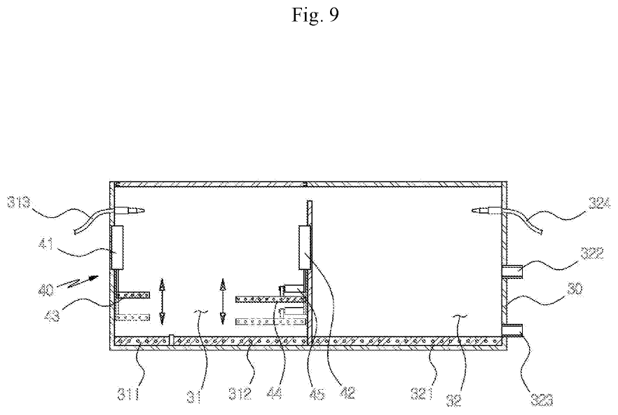

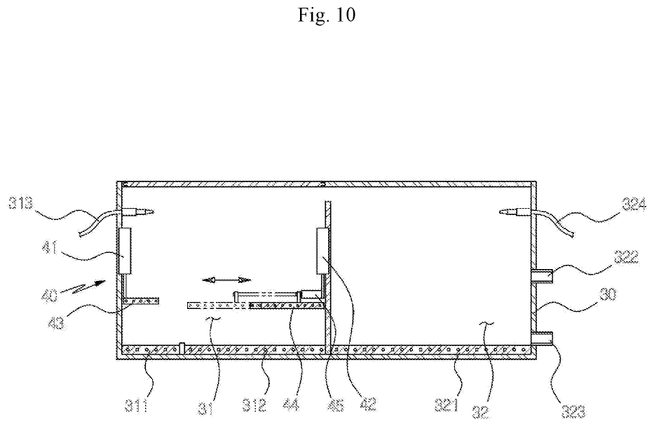

FIG. 1 is a perspective view illustrating a cooking robot with a food ingredient processing and automatic cooking structure according to an embodiment. FIG. 2 is a front view illustrating a cooking robot with a food ingredient processing and automatic cooking structure according to an embodiment. FIG. 3 is a plan view illustrating a cooking robot with a food ingredient processing and automatic cooking structure according to an embodiment. FIG. 4 is a cross-sectional view illustrating a cooking robot with a food ingredient processing and automatic cooking structure according to an embodiment. FIG. 5 is a view illustrating an operation state of a cooking robot with a food ingredient processing and automatic cooking structure according to an embodiment. FIG. 6 is a view illustrating a cutting means of a cooking robot with a food ingredient processing and automatic cooking structure according to an embodiment. FIG. 7 is a cross-sectional view illustrating a cutting means of a cooking robot with a food ingredient processing and automatic cooking structure according to an embodiment. FIG. 8 is a cross-sectional view illustrating an operation state of a cooking robot with a food ingredient processing and automatic cooking structure according to an embodiment. FIG. 9 is a cross-sectional view illustrating an operation state of a pressurizing/heating means of a cooking robot with a food ingredient processing and automatic cooking structure according to an embodiment. FIG. 10 is a cross-sectional view illustrating an operation state of a conveying cylinder of a cooking robot with a food ingredient processing and automatic cooking structure according to an embodiment.

Referring to the drawings, according to an embodiment, a cooking robot 10 with a food ingredient processing and automatic cooking structure (hereinafter, simply referred to as “cooking robot 10”) may cut and process food ingredients and cook them by heat. The cooking robot 10 includes an ingredient preparing housing 20 and an ingredient cooking housing 30.

The ingredient preparing housing 20 may be formed of metal or synthetic resin, e.g., plastic. The ingredient preparing housing 20 includes an ingredient putting hole 211 in the top thereof, through which ingredients are put, and a cutting chamber 21 including a cutting means 22, e.g., a cutter, for cutting incoming food ingredients.

The cutting means 22 may include a cutting cylinder 221 welded or screwed to the inner top side of the cutting chamber 21, a cutting panel 222 screwed and fastened to cutting shaft of the cutting cylinder 221, and cutting blades 223 the respective ends of which are welded to the cutting panel 222, spaced apart from each other at predetermined intervals. When ingredients are put in the cutting chamber 21 through the ingredient putting hole 211, the cutting cylinder 221 may be operated to cut the ingredients.

A slidable connection door is provided at the lower part of the ingredient preparing housing 20. The slidable connection door is open so that the food ingredients cut in the cutting chamber 21 are fed to the ingredient cooking housing 30.

The slidable connection door may have a handle so that the user may grab the handle to open or close the slidable connection door.

The ingredient preparing housing 20 may further include a transmission shaft. A transmission shaft of the transmission cylinder may be connected to the slidable connection door, and the transmission cylinder may be operated to move (e.g., open or close) the slidable connection door.

The ingredient cooking housing 30 may be formed of metal or synthetic resin, e.g., plastic. The ingredient cooking housing 30 includes a heat cooking chamber 31 which has a first heating panel 311 and a second heating panel 312 at the lower side thereof to receive the food ingredients treated or processed in the ingredient preparing housing 20 and heat and cook the food ingredients.

Heating wires are provided inside the first heating panel 311 and the second heating panel 312 to heat the first heating panel 311 and the second heating panel 312.

The ingredient cooking housing 30 may have a top opening. The ingredient cooking housing 30 may be detachably fitted into the lower part of the ingredient preparing housing 20 or the ingredient cooking housing 30 may be screwed and fastened to the lower part of the ingredient preparing housing 20.

The ingredient cooking housing 30 may include a withdrawal door for pulling out the food cooked by the first heating panel 311 and the second heating panel 312. Alternatively, the ingredient preparing housing 20 may be separated from the ingredient cooking housing 30 to pull out the cooked food.

The ingredient cooking housing 30 may further include an oil feeder 313 which has a nozzle structure to supply oil from an outside source to the first heating panel 311 and the second heating panel 312.

In the cooking robot 10, food ingredients are put in the ingredient cooking housing 30. Food ingredients may be cut to a predetermined size, and the cut food ingredients are delivered to the ingredient cooking housing 30 in which the food ingredients are then heated and cooked. Thus, the cooking robot 10 enables quick treatment and cooking of food ingredients.

The first heating panel 311 may be formed to be narrower than the second heating panel 312 so that the food ingredients are heated and cooked fitting the size of the food ingredients.

The ingredient preparing housing 20 may have a crushing chamber 23 to crush food ingredients. A crushing panel 231 with multiple crushing holes 231a is provided in the top side of the crushing chamber 23. If the user pushes and rubs food ingredients against the top of the crushing panel 231, the food ingredients may be stuck to the crushing holes 231a and some of the food ingredients are cut or chopped and passed through the crushing holes 231a. The slidable connection door is open and the chopped food ingredients are moved to the ingredient cooking housing 30 and, together with the food ingredients fed from the cutting chamber 21, are heated and cooked.

The ingredient preparing housing 20 includes a mixing chamber 24. The mixing chamber 24 has a mixing/kneading means 25 (e.g., a mixer or kneader). The mixing/kneading means 25 includes a bowel casing 251 disposed in and screwed to the mixing chamber 24, a connecting shaft 252 one end of which is screwed or welded to an inner surface of the mixing chamber 24, a mixing motor 253 screwed to the other end of the connecting shaft 252, and a mixing/kneading unit 254 coupled to a mixing shaft of the mixing motor 253. The mixing/kneading means 25 stirs, mixes or blends and kneads food ingredients put in the bowl casing 251.

A coupling tube is provided on the upper side of the mixing/kneading unit 254 and is fitted over and screwed and fastened to the mixing shaft, and the mixing/kneading unit 254 has a plurality of mixing bars at a lower side thereof to stir, mix, or blend food ingredients.

The ingredient cooking housing 30 includes a soup cooking chamber 32 to cook a soup. The soup cooking chamber 32 has a soup heating panel 321 at a lower side thereof. A feeding tube 322 with a valve is provided to feed water to the soup cooking chamber 32. A discharge tube 323 with a valve is provided to discharge the cooked soup. The ingredient cooking housing 30 may further include a source supplying unit 324 (e.g., a source dispenser) to supply a seasoning or sauce to the soup cooking chamber 32.

Heating wires may be inserted and formed inside the soup heating panel 321 to heat the soup heating panel 321.

A barrier panel may be formed in the ingredient cooking housing 30 to partition and divide the heat cooking chamber 31 and the soup cooking chamber 32, thereby filling water for cooking a soup.

Water and sauce may be supplied to the soup cooking chamber 32 and be heated by the soup heating panel 321, cooking a soup. The cooked soup may be discharged through the discharge tube 323, so that the user may enjoy the soup.

The ingredient cooking housing 30 may further include a pressing/heating means 40 to press down and heat food ingredients put on the first heating panel 311 and the second heating panel 312. The pressing/heating means 40 may include a first operation cylinder 41 screwed and fastened to an inner side surface of the heat cooking chamber 31 and disposed over the first heating panel 311, a second operation cylinder 42 screwed and fastened to an inner side surface of the heat cooking chamber 31 and disposed over the second heating panel 312, a first elevation pressing/heating panel 43 welded to an operation shaft of the first operation cylinder 41 to be moved up or down by the operation of the first operation cylinder 41, and a second elevation pressing/heating panel 44 welded to an operation shaft of the second operation cylinder 42 to be moved up or down by the operation of the second operation cylinder 42.

The first elevation pressing/heating panel 43 may be disposed over the first heating panel 311 to press down and heat food ingredients on the first heating panel 311. The second elevation pressing/heating panel 44 may be disposed over the second heating panel 312 to press down and heat food ingredients on the second heating panel 312.

Heating wires may be inserted and provided inside the first elevation pressing/heating panel 43 and the second elevation pressing/heating panel 44. The first elevation pressing/heating panel 43 and the second elevation pressing/heating panel 44 are heated by the heating wires.

The second operation cylinder 42 may be screwed and fastened to the barrier panel formed in the ingredient cooking housing 30.

The first elevation pressing/heating panel 43 and the second elevation pressing/heating panel 44 may press down and heat the food ingredients (or press and heat upper portions of the food ingredients), and the first heating panel 311 and the second heating panel 312 may heat lower portions of the food ingredients. Thus, the food ingredients may be cooked quickly.

A conveying cylinder 45 may be installed on the operation shaft of the second operation cylinder 42 to prevent the incoming food ingredients from being stuck to the top side of the second elevation pressing/heating panel 44 and to evenly press and heat the upper portions of the food ingredients on the second heating panel 312.

The second elevation pressing/heating panel 44 may be welded or screwed to a conveying shaft of the conveying cylinder 45 by a connecting shaft and be moved up or down by the second operation cylinder 42 and conveyed by the operation of the conveying cylinder 45.

Rotating motors may be formed at the operation shafts of the first operation cylinder 41 and the second operation cylinder 42, and the respective ends of the first elevation pressing/heating panel 43 and the second elevation pressing/heating panel 44 may be screwed to the rotating shaft of the rotating motor. if food ingredients are put and accumulated on the first elevation pressing/heating panel 43 and the second elevation pressing/heating panel 44, the rotating motor may rotate, allowing the food ingredients to freely fall to the first heating panel 311 and the second heating panel 312.

Vibrators may be screwed to the first operation cylinder 41 and the second operation cylinder 42. Vibrations created by the vibrators may be transferred to the first elevation pressing/heating panel 43 and the second elevation pressing/heating panel 44 and hence to the food ingredients while the food ingredients are pressed. Thus, the food ingredients may be spread flat and even, so that press and heat may be evenly or uniformly delivered to the food ingredients. Further, when the first elevation pressing/heating panel 43 and the second elevation pressing/heating panel 44 are rotated, the food ingredients accumulated on the first elevation pressing/heating panel 43 and the second elevation pressing/heating panel 44 may be moved to the first heating panel 311 and the second heating panel 312 by the vibrations.

According to various embodiments, a cooking robot with a food ingredient processing and automatic cooking structure may address the foregoing issues and prevent accidents, shorten cooking time, and enable cooking of various foods substantially simultaneously.

While the disclosure has been shown and described with reference to exemplary embodiments thereof, it will be apparent to those of ordinary skill in the art that various changes in form and detail may be made thereto without departing from the spirit and scope of the disclosure as defined by the following claims. It should be noted that the present invention is not limited to the above-described embodiments. Accordingly, the scope of the present invention should be determined by the technical spirit of the invention as claimed in the claims. It should also be noted that all modifications or equivalents of the present invention belong to the scope of the present invention without departing from the spirit of the present invention.

What is claimed is:

1. A cooking robot, comprising:
an ingredient preparing housing, the ingredient preparing housing including an ingredient entry hole through which a food ingredient is put and a cutting chamber with a cutting means; and
an ingredient cooking housing including a heat cooking chamber configured to receive the processed food ingredient from the ingredient preparing housing, heat, and cook the food ingredient, the heat cooking chamber including a first heating panel and a second heating panel at a lower side thereof, wherein the cutting means includes a cutting cylinder formed at an inner upper side of the cutting chamber, a cutting panel formed at a cutting shaft of the cutting cylinder, and cutting blades formed at the cutting panel and spaced apart from each other at predetermined intervals, and wherein the ingredient cooking housing further includes an oil feeder configured to supply an oil to the first heating panel and the second heating panel.

2. The cooking robot of claim 1, wherein the ingredient preparing housing includes a crushing chamber configured to crush the food ingredient, and wherein a crushing panel with a plurality of crushing holes is provided at an upper side of the crushing chamber.

3. The cooking robot of claim 1, wherein the ingredient preparing housing includes a mixing chamber with a mixing/kneading means, and wherein the mixing/kneading means includes a bowl casing disposed in the mixing chamber, a connecting shaft with a first end fastened to an inner side of the mixing chamber, a mixing motor fastened to a second end of the connecting shaft, and a mixing/kneading unit coupled to a mixing shaft of the mixing motor.

4. The cooking robot of claim 1, wherein the ingredient cooking housing includes a soup cooking chamber configured to cook a soup, wherein the soup cooking chamber includes a soup heating panel at a lower side thereof, wherein a supply tube is formed to supply water to the soup cooking chamber in the ingredient cooking housing, and a discharge tube is formed to discharge the cooked soup, and wherein the ingredient cooking housing further includes a source supplying unit configured to supply a seasoning or sauce to the soup cooking chamber.

5. The cooking robot of claim 1, wherein the ingredient cooking housing further includes a pressing/heating means configured to press and heat an upper portion of the food ingredient on the first heating panel and the second heating panel, wherein the pressing/heating means includes a first operation cylinder formed on an inner side surface of the heat cooking chamber and disposed over the first heating panel, a second operation cylinder formed on an inner side surface of the heat cooking chamber and disposed over the second heating panel, a first elevation pressing/heating panel formed at an operation shaft of the first operation cylinder to be moved up or down by operation of the first operation cylinder, and a second elevation pressing/heating panel formed at an operation shaft of the second operation cylinder to be moved up or down by operation of the second operation cylinder, and wherein the first elevation pressing/heating panel is disposed over the first heating panel to press and heat an upper portion of the food ingredient on the first heating panel, and the second elevation pressing/heating panel is disposed over the second heating panel to press and heat an upper portion of the food ingredient.

6. The cooking robot of claim 1, wherein a conveying cylinder is installed on the operation shaft of the second operation cylinder to prevent the incoming food ingredient from being stuck and to evenly press and heat the upper portion of the food ingredient on the second heating panel, and wherein the second elevation pressing/heating panel is installed on a conveying shaft of the conveying cylinder to be moved up or down by the second operation cylinder and conveyed by operation of the conveying cylinder.
